(19) United States
(12) Patent Application Publication
(10) Pub. No.: US 2026/0018069 A1
(43) Pub. Date: Jan. 15, 2026

(54) SYSTEMS AND METHODS FOR COORDINATED LANDING, ACCESS CONTROL, AND SECURE COMMUNICATION FOR AUTONOMOUS AERIAL VEHICLES

(71) Applicant: Bell-Dancy LLC, Culver City, CA (US)

(72) Inventor: Darrell Bell-Dancy, Culver City, CA (US)

(73) Assignee: Darrell Bell-Dancy, Culver City, CA (US)

(21) Appl. No.: 19/270,290

(22) Filed: Jul. 15, 2025

Related U.S. Application Data
(60) Provisional application No. 63/671,530, filed on Jul. 15, 2024.

(51) Int. Cl. G08G 5/59; G05B 13/02; G08G 5/54; G08G 5/57; H04L 9/00; H04L 9/32; H04W 12/122; H04W 12/64

(52) U.S. Cl. CPC G08G 5/59; G05B 13/0265; G08G 5/54; G08G 5/57; H04L 9/3234; H04L 9/3263; H04L 9/50; H04W 12/122; H04W 12/64; H04L 2209/84

(57) ABSTRACT

A system and method for managing autonomous aerial vehicle ingress and payload exchange is disclosed. A beacon unit receives a digitally encoded ingress request from an autonomous aerial vehicle, the request comprising an identity token. A smart contract engine evaluates the identity token against mission-specific conditions to authorize ingress. An environmental analysis processor generates a map of the region surrounding the beacon unit using data from multiple sensor modules, including LiDAR, radar, infrared, audio, and weather sensors. A trajectory guidance engine computes an ingress path based on the environmental map. A virtual protected area generation module defines a three-dimensional protected zone for descent, and a classification engine assigns a safety classification to the zone based on predefined criteria. A beacon control interface transmits the ingress path to the vehicle and monitors descent for compliance. A user authentication subsystem verifies the identity of a human user at the landing zone prior to payload release.

### CROSS-REFERENCE TO RELATED APPLICATIONS

This application claims the benefit of U.S. Provisional Application No. 63/671,530, filed 15 Jul. 2024, which is incorporated in its entirety by this reference.

### TECHNICAL FIELD

The present application relates generally to autonomous aerial vehicle systems and, more particularly, to systems and methods for managing coordinated access, secure communication, and landing operations for unmanned aerial vehicles using decentralized communication protocols, authenticated access control, and dynamic infrastructure nodes.

### BACKGROUND

Autonomous aerial vehicles, including unmanned aerial systems (UAS) and electric vertical takeoff and landing (eVTOL) aircraft, have gained widespread adoption across a range of commercial, industrial, and governmental applications. These platforms are frequently tasked with autonomous delivery, inspection, surveillance, and transport missions in both urban and rural environments. As such vehicles increasingly operate without direct human oversight, robust systems for coordinating airspace access, verifying mission authorization, and securing command and control communications may be accurately and safely implemented.

In particular, managing the landing and takeoff of autonomous aerial vehicles in dynamic, distributed environments present numerous technical challenges. Existing systems often rely on fixed infrastructure, centralized routing logic, or limited-range communications, which can restrict flexibility and scalability. Furthermore, coordination among multiple stakeholders, including infrastructure nodes, fleet operators, and end-users, can be hindered by insufficient mechanisms for secure task initiation, identity verification, and failover response.

Additional complications arise when attempting to protect operational integrity and safety in congested or sensitive airspaces. Verifying that a particular vehicle may be authorized to access a specific landing zone, hand off a payload, or execute a programmed route typically involves proprietary protocols or ad hoc network configurations, which may be vulnerable to signal spoofing, unauthorized access, or communication loss.

As demand increases for more reliable, scalable, and secure autonomous aerial systems, improved techniques are needed to facilitate decentralized coordination, enforce access controls, and enable responsive, infrastructure-aware operations across diverse flight scenarios.

The embodiments of the present application described herein provide technical solutions that address, at least the needs described above.

### BRIEF DESCRIPTION OF THE FIGURES

FIG. 1 illustrates a schematic representation of the System 100 in accordance with one or more embodiments of the present application.

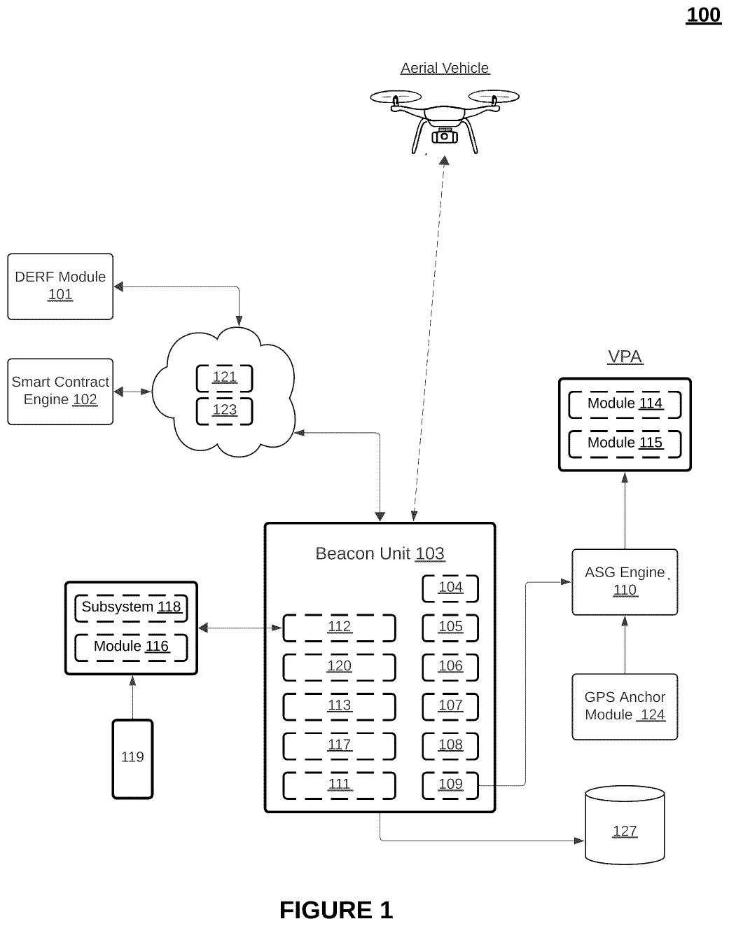

FIG. 2 illustrates an example method 200 in accordance with one or more embodiments of the present application; and

FIGS. 3A-3C illustrate an implementing of a beacon source that facilitates a traffic flow and/or ingress operation of one or more aerial autonomous vehicles in accordance with one or more embodiments of the present application.

### BRIEF SUMMARY OF THE EMBODIMENTS

In one embodiment, a computer-implemented method for managing autonomous aerial vehicle ingress and payload exchange includes receiving, by a beacon unit, a digitally encoded ingress request from an autonomous aerial vehicle, the ingress request comprising an identity token associated with a delivery or retrieval operation. The method further includes evaluating, by a smart contract engine, the identity token against a mission-specific condition set to determine whether the autonomous aerial vehicle may be authorized to initiate ingress operations.

In one embodiment, the method includes generating, by an environmental analysis processor, an environmental map of a region surrounding the beacon unit using data from a plurality of sensor modules comprising a LiDAR sensor array, a radar sensor module, an infrared sensor unit, an audio sensor unit, and a weather monitoring unit. A trajectory guidance engine computes an ingress path for the autonomous aerial vehicle based on the environmental map and a location of the beacon unit.

In one embodiment, a virtual protected area generation module generates a three-dimensional protected zone for descent and landing of the autonomous aerial vehicle. A classification engine assigns a safety classification to the virtual protected area based on the environmental map and one or more system-defined safety criteria.

In one embodiment, a beacon control interface transmits the ingress path to the autonomous aerial vehicle and monitors descent compliance with the ingress path. A user authentication subsystem verifies an identity of a human user located at the landing zone before authorizing release of a payload by the autonomous aerial vehicle.

In one embodiment, the method includes authenticating the autonomous aerial vehicle by parsing the ingress request to extract credential metadata including a signed certificate and mission identifier and verifying the credential metadata against a distributed identity registry maintained by a registered relay station.

In one embodiment, evaluating the identity token comprises executing a smart contract that defines delivery authorization parameters based on at least one of: (i) a delivery time window, (ii) a location constraint relative to the beacon unit, and (iii) an identity of the intended recipient, wherein the smart contract may be cryptographically validated using a blockchain-based authentication framework.

In one embodiment, receiving the digitally encoded ingress request includes detecting, by the beacon unit, a proximity-based signal transmitted by the autonomous aerial vehicle using a wireless communication protocol, wherein the beacon unit initiates an ingress protocol in response to detecting the signal.

In one embodiment, the beacon unit includes a logic cycle processor configured to transition the system from an idle state to an active coordination state upon detection of the autonomous aerial vehicle within a predefined geofence radius. The beacon unit further verifies that bidirectional communication has been established by executing a multi-phase handshake protocol prior to authorizing descent.

In one embodiment, the beacon unit monitors real-time telemetry from the autonomous aerial vehicle during descent to verify compliance with the ingress path and issues a hold or abort command if a deviation from a predefined compliance boundary may be detected. The beacon unit also broadcasts a visual indicator signal via a visual indicator assembly to signify a current landing status, including a first state indicating ingress approval and a second state indicating restricted airspace.

In one embodiment, the beacon unit comprises a transceiver module configured to relay environmental status updates and ingress coordination instructions to the autonomous aerial vehicle using digitally encoded, cryptographically signed transmissions.

In one embodiment, the trajectory guidance engine generates a plurality of candidate descent vectors based on obstacle boundaries identified in the environmental map and selects an optimal ingress path that minimizes lateral deviation and descent time while maintaining compliance with predefined safety thresholds.

In one embodiment, generating the three-dimensional protected zone includes defining a set of virtual boundary coordinates that form a geofenced volume around the beacon unit, wherein the boundaries are dynamically sized based on at least one of: an ambient obstacle density, a forecasted weather condition, and a size classification of the autonomous aerial vehicle.

In one embodiment, assigning the safety classification includes computing a risk score based on environmental variables within the virtual protected area, including obstacle motion vectors, thermal gradients, and ambient wind variability, and mapping the risk score to a predefined classification tier selected from a plurality of safety levels.

In one embodiment, monitoring descent compliance includes tracking the position and orientation of the autonomous aerial vehicle in real time using telemetry signals received from the vehicle and comparing the tracked flight data against the ingress path to detect deviations exceeding a predefined compliance threshold.

In one embodiment, the beacon unit is further configured to dynamically modify the ingress path in response to a change in environmental conditions detected during descent of the autonomous aerial vehicle.

In one embodiment, upon successful payload exchange, the beacon unit transmits a delivery confirmation signal to the autonomous aerial vehicle and to a remote relay station, the confirmation signal including a transaction identifier and payload status.

In one embodiment, the ingress request includes a unique flight mission code, and the smart contract engine may be configured to determine a mission-specific behavioral policy based on the flight mission code prior to authorizing ingress.

In one embodiment, the method includes recording, by a system logging module, a full ingress session log comprising vehicle telemetry, authentication events, environmental snapshots, compliance violations, and payload transfer status, wherein the ingress session log may be stored for audit or forensic review.

In one embodiment, the beacon unit may be configured to perform omnidirectional commanding by broadcasting ingress coordination instructions simultaneously across a plurality of directional communication channels. The omnidirectional broadcast includes ingress approval, hold, or abort signals, each digitally encoded and cryptographically validated to enable secure and simultaneous communication with multiple aerial vehicles or ground systems within the beacon's broadcast radius.

In one embodiment, a system for managing autonomous aerial vehicle ingress and payload exchange includes a beacon unit configured to define a landing zone and interact with an autonomous aerial vehicle; a communication module configured to receive a digitally encoded request including an identity token; a smart contract engine; an environmental analysis processor with a plurality of sensor modules; a trajectory guidance engine; a virtual protected area generation module; a classification engine; a beacon control interface; and a user authentication subsystem.

In one embodiment, a method includes receiving and evaluating an ingress request, generating an environmental map, computing and transmitting an ingress path, generating and classifying a protected descent zone, and verifying user identity before authorizing payload release.

### DESCRIPTION OF THE PREFERRED EMBODIMENTS

The following description of the preferred embodiments of the present application is not intended to limit the scope of the embodiments to these preferred embodiments, but rather to enable any person skilled in the art to make and use these embodiments of the present application.

### Terminology

As used herein, unless otherwise specified, the following terms have the meanings provided below:

The term beacon unit refers to a localized coordination device comprising one or more subsystems for communication, sensing, processing, and control, the beacon unit being configured to coordinate ingress operations of an autonomous aerial vehicle and to manage interaction with associated users and systems within a defined operational region.

The term ingress request refers to a digitally encoded communication signal transmitted by an autonomous aerial vehicle to the beacon unit, the ingress request comprising operational metadata including, but not limited to, an identity token, mission identifier, and credential metadata for initiating a delivery or retrieval operation.

The term identity token refers to a cryptographically generated identifier associated with a specific delivery or retrieval task; the token being evaluated by a smart contract engine to determine mission authorization and access control for ingress operations.

The term smart contract engine refers to a computational module configured to execute condition-based digital contracts, the contracts being implemented to verify mission compliance parameters and to authorize or restrict aerial vehicle ingress based on evaluated identity token content.

The term environmental map refers to a structured digital representation of the area surrounding the beacon unit, the map being generated from sensor data including LiDAR, radar, infrared, audio, and weather modules, and comprising obstacle boundaries, terrain features, environmental conditions, and flight path constraints.

The term virtual protected area refers to a three-dimensional geospatial volume defined by the system to enable safe descent and landing of an autonomous aerial vehicle, the area being dynamically configured in size, location, and boundary characteristics based on environmental and operational data.

The term safety classification refers to a designation assigned to a virtual protected area based on computed risk values, the classification indicating suitability of the area for aerial vehicle descent and determined according to predefined thresholds involving obstacle proximity, weather conditions, motion dynamics, and thermal or wind variability.

The term ingress path refers to a computed trajectory for aerial vehicle descent toward the beacon unit, the path being optimized for environmental constraints, mission objectives, and safety thresholds, and comprising one or more descent vectors evaluated for compliance.

The term descent compliance monitoring refers to the process of evaluating telemetry data transmitted from the aerial vehicle during ingress, the telemetry including positional, directional, and speed information, and comparing the data against the ingress path to detect deviations and trigger corrective commands.

The term omnidirectional commanding refers to a mode of broadcast communication executed by the beacon unit in which ingress coordination instructions are transmitted simultaneously across multiple directional channels to one or more aerial vehicles or ground stations, the instructions including ingress approval, hold, and abort signals, each digitally encoded and cryptographically signed.

The term mission-specific condition set refers to a set of criteria used to evaluate ingress authorization, the condition set being defined by a smart contract and potentially including delivery time windows, geographic constraints, authorized recipient identities, or vehicle-specific requirements.

The term human user identity verification refers to the process of confirming the identity of a recipient at the landing zone, the process being executed by a user authentication subsystem and based on biometric, tokenized, or credential-based input prior to payload release.

The term geofence radius refers to a predefined radial boundary around the beacon unit used to detect the proximity of an autonomous aerial vehicle and to transition the beacon unit between system states such as idle, coordination, or active ingress.

The term telemetry refers to a data stream generated by the autonomous aerial vehicle, the stream comprising operational parameters such as GPS coordinates, altitude, orientation, velocity, and system health data, and transmitted to the beacon unit during ingress and landing operations.

The term cryptographically signed transmission refers to a digital communication packet secured by one or more cryptographic techniques such as digital signatures or certificates, the signing ensuring authenticity, integrity, and non-repudiation of transmitted ingress coordination data.

### 1. System for Coordinated Autonomous Aerial Vehicle Ingress and Payload Exchange

System 100 may be configured to facilitate coordinated landing, access control, and secure communication for autonomous aerial vehicles operating in decentralized environments. In some embodiments, System 100 may include a plurality of infrastructure components distributed across a geographic area and communicatively linked through a secure, blockchain-enabled communication framework. The components of System 100 may operate cooperatively to authenticate mission requests, generate landing trajectories based on real-time environmental conditions, verify user and vehicle credentials, and enable encrypted data exchange among aerial vehicles and supporting ground nodes. In various embodiments, System 100 may be implemented to support dynamic flight operations, autonomous payload transfers, and real-time traffic management for unmanned aerial systems (UAS) and other autonomous aerial platforms.

### 1.01 DERF Communication Module

DERF Communication Module 101 may be configured to facilitate encrypted, decentralized command and control signaling between autonomous aerial vehicles and infrastructure components of System 100. In some embodiments, DERF Communication Module 101 may implement a blockchain-based communication protocol that encapsulates control messages in digitally signed payloads. These payloads may include metadata identifying one or more intended recipients, access permissions, and mission parameters, and may be distributed over a radio frequency (RF) channel.

In various implementations, DERF Communication Module 101 may utilize a decentralized application (DApp) framework to manage signal formatting, encryption, and decryption. Command signals may be wrapped in a blockchain transaction structure and broadcast or transmitted to infrastructure nodes and aerial vehicles within communication range. Each receiving node may be configured to parse the message header and evaluate whether it matches metadata associated with a registered token, credential, or other permissioned access identifier. In some embodiments, DERF Communication Module 101 may interoperate with Smart Contract Engine 102 to determine access eligibility based on role-specific or token-specific policies.

DERF Communication Module 101 may further support multi-blockchain interoperability, enabling network and frequency hopping to reduce signal interference and support operational resiliency. In some implementations, the module may employ token-gated decryption such that only authenticated entities possessing a valid key or access token may read or execute the contents of the command signal. DERF Communication Module 101 may also include logic for persistent header messaging, allowing multiple authorized recipients to receive a signal simultaneously, with selective parsing based on in-group metadata matching.

In certain embodiments, DERF Communication Module 101 may be deployed at both aerial and ground nodes of System 100, including within Beacon Unit 103, Registered Relay Station 121, or UAS-mounted onboard controllers. The communication module may also log relevant message events to a distributed ledger or other audit system for historical tracking, compliance, and integrity verification.

### 1.02 Smart Contract Engine

Smart Contract Engine 102 may be configured to enforce access control policies for DERF-based communications within System 100. In some embodiments, Smart Contract Engine 102 may be implemented as part of a blockchain runtime environment, such as a Hyperledger Fabric, Ethereum-compatible chain, or other distributed ledger system capable of executing decentralized access logic.

Smart Contract Engine 102 may receive command signals or access requests originating from DERF Communication Module 101 and evaluate such requests against a set of predefined access criteria. These criteria may be encoded in one or more smart contracts that define permissible actions based on token ownership, digital identity, user role, or mission parameters. For example, a smart contract may authorize execution of a DERF-encoded payload only if the requesting entity presents a valid token corresponding to a specific vehicle, mission, or authorized user group.

In various embodiments, Smart Contract Engine 102 may implement one or more contract functions such as checkAccess, unlockAccess, or verifyToken, each designed to evaluate whether a communication, task, or landing request satisfies a rule set stored on the ledger. These functions may return access flags, permission levels, or denials that dictate whether a DERF signal may be decrypted, relayed, or acted upon by the recipient node.

Smart Contract Engine 102 may also support dynamic policy evaluation. For instance, mission-specific smart contracts may be instantiated on demand, with customized logic governing the scope of permitted actions during a particular time window or for a specified geographical zone. In such embodiments, Smart Contract Engine 102 may enable time-limited or location-bound control over landing, takeoff, or payload exchange operations.

In some implementations, Smart Contract Engine 102 may be co-located with DERF Communication Module 101 at edge nodes such as Beacon Unit 103 or onboard drone hardware or may alternatively be deployed on cloud-based infrastructure accessible to BRS node 121 or other components of System 100. Smart Contract Engine 102 may also log access decision outcomes to a distributed ledger or off-chain storage system to enable auditability, facilitate compliance verification, and support forensic analysis in the event of unauthorized activity.

### 1.03 Beacon Unit

Beacon Unit 103 may be configured to facilitate autonomous landing and takeoff operations for aerial vehicles by generating real-time trajectory guidance and managing localized environmental data within System 100. In some embodiments, Beacon Unit 103 may be physically deployed at a designated landing or takeoff site, such as a rooftop, ground pad, or mobile docking station, and may be communicatively coupled with other nodes in System 100 via DERF Communication Module 101.

Beacon Unit 103 may include a plurality of sensors configured to detect environmental, spatial, and operational parameters in the surrounding airspace and landing zone. Such sensors may include LiDAR Sensor Array 104, Radar Sensor Module 105, Infrared Sensor Unit 106, Audio Sensor Unit 107, and Weather Monitoring Unit 108. These sensing components may operate in coordination to generate an aggregated environmental dataset, which may be processed by Environmental Analysis Processor 109 to determine safe and optimal landing or departure conditions.

In various implementations, Beacon Unit 103 may further include Active Sensing Guidance (ASG) Engine 110 configured to compute three-dimensional ingress and egress trajectories for incoming or outgoing aerial vehicles. The ASG Engine 110 may take into account real-time environmental data, vehicle metadata, and system-wide traffic conditions to generate adaptive path planning outputs that minimize risk and optimize landing efficiency. These outputs may be used to direct aerial vehicles toward specific approach vectors, queue positions, or holding patterns.

Beacon Unit 103 may also include RF Transceiver Module 111 to facilitate encrypted communication with authorized aerial vehicles and nearby infrastructure components. In some embodiments, RF Transceiver Module 111 may receive DERF-wrapped command signals and broadcast beacon-specific instructions or availability signals in response. Beacon Control Interface 112 may coordinate the timing, sequencing, and verification of such transmissions in accordance with policy rules or system status.

In some embodiments, Beacon Unit 103 may further include Visual Indicator Assembly 113 to present real-time status information to users, personnel, or approaching aerial vehicles. For example, Visual Indicator Assembly 113 may display availability signals using color-coded lighting states (e.g., green for available, yellow for queued, red for unavailable), which may correspond to zone classifications or access permissions determined by VPA Classification Engine 115.

Beacon Unit 103 may also be configured to activate or control generation of Virtual Protected Areas (VPAs) via VPA Generation Module 114. These VPAs may define geofenced landing zones with dynamic boundary parameters based on sensed environmental and operational data. In some cases, the VPAs may be tailored to accommodate specific aircraft classes, payload types, or mission categories.

In certain embodiments, Beacon Unit 103 may operate autonomously or under supervision from a Registered Relay Station 121, and may be configured to log landing events, environmental conditions, and authorization outcomes to System Logging Database 127 or an external recordkeeping system. Beacon Unit 103 may thereby enable secure, context-aware landing operations in both static and mobile deployment environments.

### 1.04 LiDAR Sensor Array

LiDAR Sensor Array 104 may be configured to capture high-resolution, three-dimensional spatial data in the vicinity of Beacon Unit 103. In some embodiments, LiDAR Sensor Array 104 may include one or more rotating or solid-state laser range-finding units capable of emitting pulses of light and measuring the return time from surrounding objects. The resulting time-of-flight data may be used to construct a detailed 3D point cloud representing the topology, obstacles, and spatial geometry of the operational environment.

LiDAR Sensor Array 104 may operate continuously or in response to a triggering event, such as an approaching aerial vehicle or a received job assignment. The point cloud data generated by LiDAR Sensor Array 104 may be provided to Environmental Analysis Processor 109, which may fuse the LiDAR data with additional environmental inputs (e.g., radar, infrared, and weather readings) to form a composite environmental map. This map may serve as an input to ASG Engine 110 for real-time trajectory generation and obstacle avoidance planning.

In certain implementations, LiDAR Sensor Array 104 may scan defined regions of interest corresponding to an active Virtual Protected Area (VPA) to detect transient or unauthorized obstructions. For example, LiDAR Sensor Array 104 may identify a foreign object, person, or animal within a landing zone, triggering a safety pause, trajectory adjustment, or system alert. In such cases, Beacon Unit 103 may prevent or delay an inbound vehicle from entering the zone until the obstruction may be resolved.

LiDAR Sensor Array 104 may also be configured to operate in concert with Visual Indicator Assembly 113 and VPA Classification Engine 115 to continuously monitor the condition of the designated landing area. For example, surface irregularities or clutter detected by LiDAR Sensor Array 104 may lead to a classification downgrade of the associated zone or dynamic resizing of the permitted landing footprint.

In some embodiments, LiDAR Sensor Array 104 may support programmable scan patterns, adjustable refresh rates, or sector prioritization based on system context or anticipated flight paths. Data collected by LiDAR Sensor Array 104 may also be timestamped, digitally signed, or recorded to System Logging Database 127 for auditability and mission traceability.

### 1.05 Radar Sensor Module

Radar Sensor Module 105 may be configured to detect and track objects in the vicinity of Beacon Unit 103 using radio frequency signals. In some embodiments, Radar Sensor Module 105 may include one or more short-range or medium-range radar transceivers capable of emitting electromagnetic pulses and measuring reflected signals to determine the position, velocity, and movement trajectory of nearby objects, including airborne vehicles, obstacles, or pedestrians.

Radar Sensor Module 105 may complement LiDAR Sensor Array 104 by providing situational awareness in conditions where optical or infrared sensing may be degraded, such as in low visibility, heavy precipitation, or smoke-filled environments. In such implementations, Radar Sensor Module 105 may operate continuously or may be triggered based on signal inputs from other components of Beacon Unit 103 or System 100.

The output of Radar Sensor Module 105 may be transmitted to Environmental Analysis Processor 109, which may incorporate radar data into a fused environmental dataset along with LiDAR, infrared, audio, and weather sensor inputs. In various embodiments, Radar Sensor Module 105 may detect and track dynamic airborne objects within a defined airspace corridor surrounding the Virtual Protected Area (VPA), such as other drones, birds, or interfering vehicles. This data may be utilized by ASG Engine 110 to generate collision-avoidance trajectories or to temporarily suspend landing operations.

Radar Sensor Module 105 may also assist in vertical traffic management by detecting relative altitude and descent rates of inbound aerial vehicles. In some implementations, Radar Sensor Module 105 may identify approach vectors and estimate time to arrival, allowing Beacon Unit 103 to prioritize landing sequence queues or issue advisory signals to incoming vehicles.

In certain embodiments, Radar Sensor Module 105 may support Doppler velocity measurements, enabling differentiation between stationary and moving targets. Radar Sensor Module 105 may also operate in tandem with RF Transceiver Module 111 to detect and verify vehicle signatures based on known signal response patterns. Data acquired by Radar Sensor Module 105 may be logged to System Logging Database 127 for operational analytics, diagnostics, or compliance auditing.

### 1.06 Infrared Sensor Unit

Infrared Sensor Unit 106 may be configured to detect thermal signatures in and around the operating area of Beacon Unit 103. In some embodiments, Infrared Sensor Unit 106 may include one or more thermal imaging arrays or infrared photodetectors capable of capturing spatial temperature gradients and radiative heat emissions from physical objects within a defined field of view.

Infrared Sensor Unit 106 may operate in conjunction with other sensing components of Beacon Unit 103, including LiDAR Sensor Array 104 and Radar Sensor Module 105, to enhance obstacle detection and environmental awareness. For example, Infrared Sensor Unit 106 may identify the presence of humans, animals, or heat-generating objects within a Virtual Protected Area (VPA) that may not be easily distinguishable through visual or radar means. In some cases, the detection of unauthorized thermal signatures within the VPA may trigger a delay, redirection, or cancellation of an inbound landing operation.

In certain implementations, Infrared Sensor Unit 106 may be used to verify user or vehicle presence during payload exchange procedures. For instance, the unit may confirm that a human recipient may be physically located at the designated drop-off location prior to authorizing the release of a payload. In such cases, Infrared Sensor Unit 106 may serve as an additional authentication layer in coordination with User Authentication Subsystem 118.

Infrared Sensor Unit 106 may also assist in identifying vehicle status during low-light conditions, where visual cues may be obscured. Thermal emissions from onboard propulsion systems or battery modules may be used to verify drone proximity, operational readiness, or alignment with designated approach vectors. In some embodiments, Infrared Sensor Unit 106 may transmit real-time thermal imagery or extracted data features to Environmental Analysis Processor 109 for integration with other sensor inputs, enabling more accurate context-aware path planning by ASG Engine 110.

In various embodiments, Infrared Sensor Unit 106 may support configurable sensitivity thresholds, scan intervals, and spatial resolution settings based on deployment conditions. Data collected by Infrared Sensor Unit 106 may be logged to System Logging Database 127 for operational records, forensic review, or thermal mapping of the deployment zone over time.

### 1.07 Audio Sensor Unit

Audio Sensor Unit 107 may be configured to monitor and analyze acoustic signals within the operational vicinity of Beacon Unit 103. In some embodiments, Audio Sensor Unit 107 may include one or more directional or omnidirectional microphones, acoustic transducers, or digital audio processors capable of capturing ambient sound and identifying audio signatures associated with aerial vehicle operations, human presence, or environmental anomalies.

Audio Sensor Unit 107 may serve as a supplementary detection modality to confirm events detected by other sensors such as LiDAR Sensor Array 104, Radar Sensor Module 105, and Infrared Sensor Unit 106. For example, Audio Sensor Unit 107 may detect the high-frequency acoustic profile of an approaching aerial vehicle, enabling early estimation of vehicle trajectory or identification of rotor configurations associated with a particular aircraft model or class.

In various implementations, Audio Sensor Unit 107 may be employed to detect human voice activity or specific audio cues (e.g., emergency alerts, distress signals, or predefined keyword phrases). Such detections may be used to support safety protocols, pause autonomous operations, or trigger additional authentication steps within User Authentication Subsystem 118. For example, a spoken command or security phrase issued by an authorized user near the landing zone may be verified by Audio Sensor Unit 107 prior to payload handoff.

Audio Sensor Unit 107 may also be configured to assess environmental sound levels for operational safety. For instance, if decibel levels exceed a specified threshold (e.g., due to nearby construction, traffic, or crowd activity), Beacon Unit 103 may postpone a landing operation or reclassify the associated VPA through VPA Classification Engine 115. Audio anomalies, such as sharp impacts or unexpected mechanical noise, may further serve as triggers for alert generation or diagnostic logging.

In some embodiments, Audio Sensor Unit 107 may include onboard signal processing capabilities to filter ambient noise, isolate relevant acoustic patterns, and compress or encode audio data for downstream analysis. Processed audio features or raw waveforms may be transmitted to Environmental Analysis Processor 109 for integration with other environmental inputs or may be stored in System Logging Database 127 for later retrieval, incident review, or compliance purposes.

### 1.08 Weather Monitoring Unit

Weather Monitoring Unit 108 may be configured to collect and report real-time atmospheric data in the vicinity of Beacon Unit 103 for use in environmental assessment, flight path computation, and zone classification. In some embodiments, Weather Monitoring Unit 108 may include one or more integrated or discrete sensors, such as a barometer, anemometer, thermometer, and humidity sensor, which may be calibrated to measure local conditions including air pressure, wind speed and direction, temperature, and relative humidity.

Weather Monitoring Unit 108 may operate continuously or may be activated in response to an approaching aerial vehicle, an active landing request, or a change in system status. In various implementations, Weather Monitoring Unit 108 may transmit meteorological readings to Environmental Analysis Processor 109, which may incorporate such data into the environmental model used to inform trajectory planning, zone safety classification, and command signal generation.

In certain embodiments, Weather Monitoring Unit 108 may identify adverse or unstable conditions that could affect the safety or precision of a landing or takeoff operation. For example, high wind speeds or sudden pressure drops may prompt the system to delay an ingress maneuver, reroute an incoming vehicle, or downgrade the classification of the associated Virtual Protected Area (VPA) through VPA Classification Engine 115. Similarly, elevated ambient temperatures may trigger dynamic adjustments to descent profiles or signal a need for thermal load management by the aerial vehicle.

Weather Monitoring Unit 108 may further support long-term learning or predictive modeling by periodically logging environmental conditions during completed flight operations. Such data may be correlated with operational outcomes to refine future routing logic, risk assessments, or infrastructure configuration. In some implementations, Weather Monitoring Unit 108 may also interface with external data sources, such as networked weather stations or regional forecasts, to augment or validate local measurements.

In certain embodiments, the sensor suite of Weather Monitoring Unit 108 may be mounted directly on Beacon Unit 103 or integrated into peripheral modules of System 100. Data output by Weather Monitoring Unit 108 may be timestamped and recorded in System Logging Database 127 for traceability, regulatory compliance, or performance benchmarking.

### 1.09 Environment Analysis Processor

Environmental Analysis Processor 109 may be configured to aggregate, interpret, and synthesize multi-modal sensor data collected by Beacon Unit 103 in order to assess current environmental and situational conditions surrounding a designated landing or takeoff zone. In some embodiments, Environmental Analysis Processor 109 may receive input from one or more of LiDAR Sensor Array 104, Radar Sensor Module 105, Infrared Sensor Unit 106, Audio Sensor Unit 107, and Weather Monitoring Unit 108.

Environmental Analysis Processor 109 may be implemented using one or more processors, embedded systems, or edge computing modules co-located with Beacon Unit 103. The processor may execute algorithms or models configured to fuse heterogeneous sensor inputs into a unified environmental dataset representing spatial geometry, obstacle locations, thermal conditions, sound signatures, meteorological variables, and dynamic activity levels within the operational area.

In various implementations, Environmental Analysis Processor 109 may normalize and correlate incoming sensor streams in real time to identify operating conditions that may affect aerial vehicle behavior or system integrity. For example, Environmental Analysis Processor 109 may combine LiDAR-derived point cloud data with thermal imagery and radar velocity tracking to detect unauthorized personnel or obstructions within a Virtual Protected Area (VPA). In such cases, the processor may flag the VPA as temporarily unsafe and transmit an alert to ASG Engine 110 or Beacon Control Interface 112 for immediate response.

Environmental Analysis Processor 109 may further assign operational status flags or generate context descriptors based on environmental patterns, including classifications such as clear, partially obstructed, high wind, high thermal interference, or auditory anomaly detected. These descriptors may serve as inputs for trajectory calculation, VPA generation, or DERF-wrapped command signal generation by other components of System 100.

In certain embodiments, Environmental Analysis Processor 109 may utilize machine learning models trained to predict operational risks or to classify environmental states based on past mission data. In such implementations, the processor may continuously improve decision accuracy through real-time feedback and event logging.

Environmental Analysis Processor 109 may output structured datasets, status codes, or signal packets to downstream modules such as ASG Engine 110, VPA Generation Module 114, or System Logging Database 127. The processor may be further configured to store historical sensor data snapshots, enabling time-based analysis or forensic reconstruction of system conditions during completed operations.

### 1.10 Active Sensing Guidance (ASG) Engine

Active Sensing Guidance (ASG) Engine 110 may be configured to compute real-time ingress and egress trajectories for autonomous aerial vehicles based on fused environmental data received from Environmental Analysis Processor 109. In some embodiments, ASG Engine 110 may be implemented as a dedicated hardware processor, embedded software module, or firmware routine co-located with Beacon Unit 103.

ASG Engine 110 may receive a unified environmental map reflecting current conditions within the vicinity of a designated Virtual Protected Area (VPA), including spatial geometry, obstacle locations, weather parameters, and dynamic object tracking. Using this data, ASG Engine 110 may calculate a safe and optimized approach path for inbound aerial vehicles and a corresponding departure path for outbound vehicles. The generated trajectories may take into account vehicle class, load profile, clearance envelopes, rotor wash constraints, and approach angle tolerances.

In various implementations, ASG Engine 110 may operate in a time-sensitive feedback loop to adapt the trajectory in response to changing environmental conditions or unexpected interference. For example, if LiDAR Sensor Array 104 detects a transient obstacle during descent, ASG Engine 110 may modify the descent path in real time and transmit revised guidance instructions to the inbound vehicle using RF Transceiver Module 111.

ASG Engine 110 may also incorporate predictive modeling to forecast future path conditions based on current environmental trends or multi-vehicle scheduling inputs. In such embodiments, the engine may dynamically assign ingress or egress time slots to reduce congestion, prevent landing overlap, and manage queueing behavior among multiple vehicles approaching a common VPA.

In certain embodiments, ASG Engine 110 may encode trajectory vectors, velocity constraints, and descent window timing into a DERF-wrapped control signal formatted for secure transmission to the target aerial vehicle. These instructions may be conditioned upon smart contract validation via Smart Contract Engine 102 and may include authentication metadata to enable execution by the intended recipient vehicle.

ASG Engine 110 may further interface with VPA Generation Module 114 to enable that the computed trajectory terminates within a zone that may be currently classified as safe and available. The engine may also log trajectory computations and decision-making rationale to System Logging Database 127 for audit, diagnostics, or operational review.

### 1.11 RF Transceiver Module

RF Transceiver Module 111 may be configured to enable secure, bidirectional radio frequency (RF) communication between Beacon Unit 103 and other components of System 100, including autonomous aerial vehicles, Registered Relay Station 121, Registered Charging Station 122, and mobile user devices operating Mobile App Interface 119. In some embodiments, RF Transceiver Module 111 may include a multi-band antenna system, signal modulator-demodulator circuitry, and digital signal processing logic suitable for transmitting and receiving DERF-encoded signals.

RF Transceiver Module 111 may serve as the physical communication layer for DERF Communication Module 101, providing a wireless channel for encapsulated command signals, status updates, trajectory instructions, and access verification metadata. In some implementations, RF Transceiver Module 111 may support both short-range and mid-range RF communication protocols, such as Wi-Fi, Bluetooth, LoRa, or other proprietary or standard RF interfaces. The module may further implement frequency hopping, spread spectrum, or directional beamforming techniques to improve signal resilience and minimize interference.

In various embodiments, RF Transceiver Module 111 may be configured to transmit beacon-specific broadcasts such as VPA availability signals, landing clearance notifications, environmental hazard alerts, and queue status information. Incoming messages from aerial vehicles may include Remote ID credentials, job status confirmations, or trajectory acknowledgments, which may be verified and parsed in conjunction with DERF Communication Module 101 and Smart Contract Engine 102.

RF Transceiver Module 111 may also participate in failover communication sequences by switching to satellite communication (via Satellite Communication Link 123) or fall-back GPS coordination (via GPS Anchor Module 124) if RF signal quality degrades below an acceptable threshold. In some implementations, the module may periodically broadcast signal health metrics or initiate handshake sequences with inbound aerial vehicles to verify communication integrity prior to authorizing landing operations.

In certain embodiments, RF Transceiver Module 111 may operate under the control of Beacon Control Interface 112, which may coordinate signal timing, transmission scheduling, and conflict resolution across multiple active beacons or vehicles. The RF module may also be configured to encrypt outbound transmissions using DERF protocols and to authenticate incoming messages using embedded cryptographic signatures or token-based access indicators.

Signal activity, transmission logs, and exception events detected by RF Transceiver Module 111 may be recorded in System Logging Database 127 for operational auditing, regulatory compliance, or diagnostic purposes.

### 1.12 Beacon Control Interface

Beacon Control Interface 112 may be configured to coordinate the operation of various subsystems within Beacon Unit 103 and manage system-level interactions with other nodes in System 100. In some embodiments, Beacon Control Interface 112 may include one or more processors, control logic circuits, and embedded software routines for executing command sequences, handling sensor orchestration, and maintaining operational state consistency across beacon components.

Beacon Control Interface 112 may receive inputs from DERF Communication Module 101, Environmental Analysis Processor 109, RF Transceiver Module 111, and other local modules, and may be configured to generate control signals that govern the activation, synchronization, and behavior of these subsystems. For example, upon receiving a landing request verified via Smart Contract Engine 102, Beacon Control Interface 112 may initiate a coordinated sensing cycle involving LiDAR Sensor Array 104, Radar Sensor Module 105, Infrared Sensor Unit 106, Audio Sensor Unit 107, and Weather Monitoring Unit 108 to assess environmental conditions for safe ingress or egress.

In various embodiments, Beacon Control Interface 112 may also manage timing and sequencing of RF broadcasts through RF Transceiver Module 111, such as issuing availability beacons, queue position updates, or VPA assignment notices to approaching aerial vehicles. In such scenarios, Beacon Control Interface 112 may prioritize signal transmission based on system context, vehicle identity, or mission criticality.

Beacon Control Interface 112 may further handle coordination between Active Sensing Guidance (ASG) Engine 110 and VPA Generation Module 114. For instance, after ASG Engine 110 computes an optimal landing trajectory, Beacon Control Interface 112 may initiate the VPA deployment process and activate Visual Indicator Assembly 113 to reflect current zone availability. The control interface may also enforce safety constraints by suspending or overriding certain operations if sensor inputs indicate unsafe or obstructed conditions.

In certain implementations, Beacon Control Interface 112 may maintain a local state machine to track current beacon mode (e.g., idle, inbound vehicle detected, environmental scan in progress, VPA active, landing authorized, payload verified, standby), and transition between states based on event triggers and timing thresholds. This state management may enable deterministic, reliable behavior even in the presence of intermittent communication or partial system degradation.

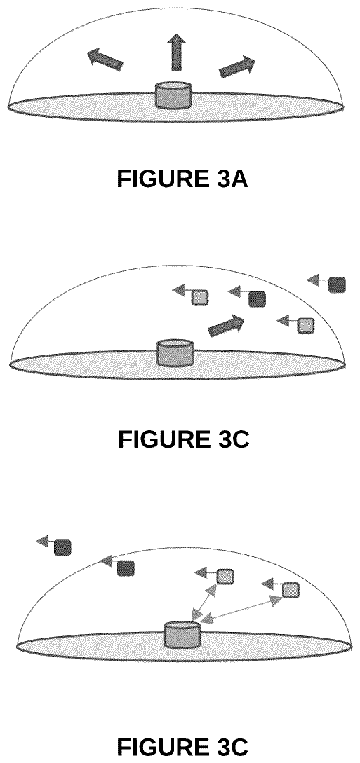

In some embodiments, the Beacon Control Interface 112 may be configured to perform omnidirectional commanding, as shown by way of example in FIGS. 3A, 3B, and 3C. Omnidirectional commanding may include broadcasting ingress coordination instructions simultaneously across a plurality of directional communication channels. The ingress coordination instructions may include ingress approval signals, hold commands, and abort directives, each digitally encoded and cryptographically signed to enable secure command integrity. The configuration of the Beacon Control Interface 112 may enable communication with multiple Autonomous Aerial Vehicles and ground-based relay systems within a defined broadcast radius. The omnidirectional broadcast architecture may support frequency-division multiplexing, spatial multiplexing, or other redundant signaling techniques to facilitate concurrent ingress coordination across multiple entities while maintaining communication robustness.

Operational status updates, control decisions, and system event logs generated by Beacon Control Interface 112 may be transmitted to System Logging Database 127 for diagnostic review, operational auditing, or post-mission analysis.

### 1.13 Visual Indicator Assembly

Visual Indicator Assembly 113 may be configured to provide real-time visual feedback regarding the operational status of a Virtual Protected Area (VPA) and associated landing operations managed by Beacon Unit 103. In some embodiments, Visual Indicator Assembly 113 may include one or more arrays of light-emitting diodes (LEDs), electronic display panels, color-coded beacons, or other visual signaling elements mounted in proximity to the designated landing or takeoff zone.

Visual Indicator Assembly 113 may be activated and controlled by Beacon Control Interface 112 in coordination with events detected by Environmental Analysis Processor 109, system state transitions, or job execution stages. For instance, when a landing area may be determined to be available and safe for ingress, Visual Indicator Assembly 113 may emit a green signal to visually communicate clearance to an approaching aerial vehicle or to personnel within line of sight. Conversely, a red signal may be activated to indicate that the VPA may be occupied, obstructed, or operating in a restricted mode. Intermediate states such as yellow or orange may be used to signal queue status, time-limited access, or pending verification.

In certain embodiments, Visual Indicator Assembly 113 may also include directional lighting or projection elements to guide the aerial vehicle toward a preferred descent vector or alignment point, supplementing guidance data provided over RF or DERF channels. In some cases, visual cues may include dynamic light patterns or flashing sequences designed to reinforce trajectory instructions or zone boundaries.

Visual Indicator Assembly 113 may further serve as a human-centric interface for indicating access authorization or payload status. For example, a unique visual code or flashing pattern may be used to signal to a human recipient that an incoming drone may be delivering an authenticated payload or that user verification has been successfully completed by User Authentication Subsystem 118.

In various implementations, Visual Indicator Assembly 113 may be adaptive based on time of day, ambient lighting, weather conditions, or sensor inputs. Brightness levels, color schemes, and timing sequences may be automatically adjusted to enable visibility and compliance with safety or aviation standards.

In some embodiments, Visual Indicator Assembly 113 may be integrated with other sensory subsystems for synchronized signaling and may log activation events or pattern selections to System Logging Database 127 for recordkeeping, mission analytics, or compliance audits.

### 1.14 VPA Generation Module

VPA Generation Module 114 may be configured to generate and manage Virtual Protected Areas (VPAs) that define secure, dynamic, and geofenced landing or takeoff zones for autonomous aerial vehicles. In some embodiments, VPA Generation Module 114 may be integrated with Beacon Unit 103 and operate in conjunction with Environmental Analysis Processor 109, ASG Engine 110, and Beacon Control Interface 112 to determine when and where to establish a VPA based on mission context, environmental conditions, and system availability.

A VPA may represent a three-dimensional spatial region bounded by virtual parameters rather than fixed physical structures. VPA Generation Module 114 may compute the boundaries of a given VPA using data derived from LiDAR Sensor Array 104, Radar Sensor Module 105, and Weather Monitoring Unit 108, as well as inputs from ASG Engine 110. The computed VPA may define a landing footprint, vertical clearance range, exclusion zones, and directional approach corridors suitable for a specific aerial vehicle or vehicle class.

In various embodiments, VPA Generation Module 114 may initiate the instantiation of a VPA when a verified job request may be received, or when an authorized aerial vehicle may be detected within proximity of the beacon. The VPA may be marked as active for a defined time window or until a termination condition may be met, such as completion of payload exchange or timeout due to vehicle absence.

VPA Generation Module 114 may dynamically resize, reposition, or dissolve a VPA in response to evolving environmental conditions or operational interruptions. For instance, if Infrared Sensor Unit 106 or Audio Sensor Unit 107 detects an unauthorized presence or unsafe noise level within the landing area, the VPA may be immediately invalidated, or its boundaries may be adjusted to exclude the affected region.

In some implementations, VPA Generation Module 114 may generate multiple overlapping or adjacent VPAs to support parallel landings, failover zones, or staggered job queuing. Each VPA may be tagged with metadata specifying classification tier, intended vehicle ID, mission token, and temporal validity. This information may be incorporated into DERF-wrapped transmissions and communicated to inbound aerial vehicles through RF Transceiver Module 111.

The parameters, lifecycle events, and classification data associated with each VPA generated by VPA Generation Module 114 may be logged in System Logging Database 127 to support traceability, mission debriefing, or regulatory reporting. In certain embodiments, the module may further support VPA replay, simulation, or remote visualization functions through integration with external control centers or operator dashboards.

### 1.15 VPA Classification Engine

VPA Classification Engine 115 may be configured to assign operational classifications to Virtual Protected Areas (VPAs) generated by VPA Generation Module 114 based on environmental conditions, physical constraints, and mission-specific requirements. In some embodiments, VPA Classification Engine 115 may evaluate real-time and historical data from sensors associated with Beacon Unit 103, including data provided by Environmental Analysis Processor 109, to determine a classification level that reflects the suitability of a given VPA for autonomous aerial vehicle operations.

The classification assigned by VPA Classification Engine 115 may define a set of operational capabilities, access permissions, or safety thresholds associated with a particular VPA. For example, classification levels may include tiered ratings (e.g., Class A, Class B, Class C, Class D) that indicate varying degrees of environmental stability, spatial clearance, obstacle density, or payload handling capabilities. Class A may represent fully unobstructed and environmentally stable conditions, while Class D may indicate marginal suitability or restricted access requiring additional safeguards.

In various implementations, VPA Classification Engine 115 may continuously monitor sensor feedback, including LiDAR and radar returns, infrared and audio detections, and weather conditions, to adjust the classification of a VPA in real time. For instance, an increase in wind speed or the detection of a nearby obstruction may result in automatic reclassification from Class A to Class B or Class C. The updated classification may be used to notify an inbound aerial vehicle to delay landing, reroute to an alternate VPA, or hold in a queue until conditions stabilize.

VPA Classification Engine 115 may also factor in drone-specific parameters such as vehicle weight, descent profile, required clearance envelope, and mission urgency. In certain embodiments, the engine may apply policy rules, machine learning models, or safety heuristics to correlate environmental inputs with appropriate classification outcomes. These classification decisions may be encoded in control signals sent to the aerial vehicle via DERF Communication Module 101 or broadcast over RF Transceiver Module 111.

In some cases, VPA Classification Engine 115 may restrict the availability of certain VPAs based on their assigned classification, permitting only pre-authorized or high-capability vehicles to access zones of lower classification. This functionality may be particularly useful in high-density deployment environments or in scenarios involving variable infrastructure constraints, such as rooftop pads with limited load-bearing capacity or obstructed line-of-sight.

VPA classifications and their corresponding rationale may be logged to System Logging Database 127 for post-mission review, safety compliance, or audit purposes. In some embodiments, classification status may also be visually reflected via Visual Indicator Assembly 113 or displayed through Mobile App Interface 119 for user awareness and coordination.

### 1.16 Payload Verification Module

Payload Verification Module 116 may be configured to authenticate and validate payload exchanges between an autonomous aerial vehicle and a recipient entity within the vicinity of Beacon Unit 103. In some embodiments, Payload Verification Module 116 may operate as part of a secure access workflow coordinated by User Authentication Subsystem 118 and Beacon Control Interface 112 and may be invoked prior to or during payload drop-off or pickup events.

Payload Verification Module 116 may receive metadata associated with a scheduled drone job, such as payload identification, recipient credentials, delivery token, or mission-specific parameters, as embedded in a DERF-wrapped signal transmitted by DERF Communication Module 101. The module may compare this metadata against real-time inputs received from local sensors or user devices to confirm that the payload is being exchanged with an authorized recipient at an authorized location.

In various implementations, Payload Verification Module 116 may utilize multiple modalities for verification, including QR code scanning, near-field communication (NFC), RF token matching, or secure challenge-response exchanges initiated by the user's mobile device operating Mobile App Interface 119. For example, when a drone reaches its landing position within the Virtual Protected Area (VPA), the recipient may present a time-sensitive access token via their mobile device, which may be validated by the system to release the payload.

In certain embodiments, Payload Verification Module 116 may also interface with Infrared Sensor Unit 106 or Audio Sensor Unit 107 to confirm physical presence, human activity, or vocal authorization from a verified user. The module may employ a multi-factor verification sequence that combines digital and physical signals to reduce the risk of unauthorized access or spoofing.

Payload Verification Module 116 may further validate the condition of the payload based on telemetry provided by the aerial vehicle, such as payload bay status, weight sensors, seal integrity indicators, or real-time video feeds. If the verification check fails at any stage, Payload Verification Module 116 may instruct Beacon Control Interface 112 to halt the payload transfer and generate a fault notification or retry sequence.

In some implementations, the module may log successful and failed payload verification events to System Logging Database 127, including associated time stamps, user identifiers, location coordinates, and payload metadata. These records may be used for auditing, dispute resolution, or operational analytics.

### 1.17 Drone Identification Module

Drone Identification Module 117 may be configured to authenticate, classify, and track autonomous aerial vehicles interacting with System 100, particularly in the context of landing operations coordinated by Beacon Unit 103. In some embodiments, Drone Identification Module 117 may be implemented as a software or firmware component integrated with RF Transceiver Module 111, DERF Communication Module 101, and Beacon Control Interface 112.

Drone Identification Module 117 may operate by receiving broadcasted or transmitted identity credentials from aerial vehicles entering the detection radius of Beacon Unit 103. These credentials may include a Remote ID signature, digital certificate, mission token, or DERF-wrapped metadata uniquely associated with a registered drone. The module may verify these credentials against a trusted registry, blockchain ledger, or distributed access control list maintained by Smart Contract Engine 102 or another identity authority.

Upon successful validation, Drone Identification Module 117 may assign a temporary operational ID, classification tag, or landing queue position to the identified vehicle. In some embodiments, the classification may include attributes such as vehicle type (e.g., quadcopter, VTOL, fixed-wing), operational tier (e.g., certified, restricted, test-mode), or payload profile. These classifications may be used to select or prioritize Virtual Protected Areas (VPAs) based on zone capabilities and safety conditions.

In various implementations, Drone Identification Module 117 may monitor signal strength, transceiver behavior, or telemetry consistency to detect spoofing attempts, signal replay attacks, or mismatches between claimed and observed vehicle behavior. When anomalies are detected, the module may trigger a verification challenge, suspend landing clearance, or alert the system operator.

Drone Identification Module 117 may also support continuous identity tracking throughout the vehicle's engagement with the beacon, including during approach, landing, payload exchange, and departure. This persistent tracking may enable accurate correlation of drone activity with recorded sensor events and user interactions.

In certain embodiments, Drone Identification Module 117 may share identity data with Payload Verification Module 116 and User Authentication Subsystem 118 to support secure, end-to-end authorization of the aerial job. Identity data may also be recorded in System Logging Database 127 for historical traceability, audit compliance, or mission analytics.

### 1.18 User Authentication Subsystem

User Authentication Subsystem 118 may be configured to verify the identity and authorization status of a human user interacting with an autonomous aerial vehicle during a job execution cycle coordinated by System 100. In some embodiments, User Authentication Subsystem 118 may operate as part of the payload access and exchange workflow, interfacing with Payload Verification Module 116, Drone Identification Module 117, and Beacon Control Interface 112 to enable that payloads are released only to authorized recipients.

User Authentication Subsystem 118 may support multiple authentication modalities, including token-based access (e.g., QR codes, RF ID tags, near-field communication), biometric inputs, password-protected mobile applications, or time-sensitive cryptographic credentials transmitted through Mobile App Interface 119. Upon detection of a pending landing event or payload delivery, User Authentication Subsystem 118 may initiate an authentication sequence by requesting user-provided credentials through a trusted interface.

In various implementations, User Authentication Subsystem 118 may compare the presented credentials against those associated with the scheduled job or mission metadata stored in a decentralized ledger or secure backend. The verification logic may be executed locally at Beacon Unit 103 or remotely via a trusted identity service, and may include checking token expiration, user-role permissions, or job-specific constraints (e.g., location match, time window validity).

Upon successful authentication, User Authentication Subsystem 118 may signal Beacon Control Interface 112 and Payload Verification Module 116 to permit payload release, initiate data logging, and trigger a visual confirmation via Visual Indicator Assembly 113. If authentication fails or produces inconclusive results, the subsystem may deny payload access, issue a retry prompt, or escalate to an override process depending on configured policy parameters.

In some embodiments, User Authentication Subsystem 118 may integrate with Audio Sensor Unit 107 or Infrared Sensor Unit 106 to confirm the physical presence and behavior of the user as part of a multi-factor authentication workflow. For example, voice recognition or heat signature confirmation may be used in conjunction with digital token matching to reduce the risk of credential misuse or spoofing.

User Authentication Subsystem 118 may log authentication events, outcomes, and associated user metadata to System Logging Database 127 to support auditing, compliance reporting, or post-operation diagnostics. In certain scenarios, the subsystem may also generate anonymized usage metrics or access pattern statistics to support system optimization and security analytics.

### 1.19 Mobile App Interface

Mobile App Interface 119 may be configured to serve as a user-accessible control and interaction layer that facilitates coordination between a human operator and various components of System 100 during the execution of drone-supported missions. In some embodiments, Mobile App Interface 119 may be implemented as a native or web-based application operable on smartphones, tablets, wearable devices, or other mobile computing platforms.

Mobile App Interface 119 may enable a user to view, initiate, or manage landing operations, payload exchanges, authentication workflows, and mission notifications associated with autonomous aerial vehicle interactions. The interface may support both end-user and administrative roles, with permission-based access to functionality such as delivery status monitoring, landing clearance acceptance, identity verification, and secure token transmission.

In various implementations, Mobile App Interface 119 may receive DERF-wrapped status updates or command acknowledgments from Beacon Unit 103 via RF, Wi-Fi, or cellular communication protocols. The app may display real-time data regarding the location of the inbound aerial vehicle, estimated time of arrival, payload metadata, or landing zone availability. It may also render alerts triggered by environmental sensors or access control modules (e.g., delays, restricted zones, or authentication failures).

Mobile App Interface 119 may further act as a conduit for user-provided authentication credentials, which may include QR code scans, biometrics (e.g., facial recognition or fingerprint), passcodes, or tap-to-confirm secure tokens. These credentials may be used by User Authentication Subsystem 118 and Payload Verification Module 116 to authorize payload retrieval or task initiation.

In certain embodiments, Mobile App Interface 119 may include a visual representation of Virtual Protected Areas (VPAs), highlighting current status, safety classification, and permissible interaction zones. The user may receive guided instructions for approaching the designated payload exchange area or may be prompted to wait in a staging area until clearance may be granted.

Mobile App Interface 119 may also support failover or escalation workflows by allowing users to report issues, reschedule landing operations, or engage with a remote support operator in the event of an error or environmental obstruction. Logs of user interactions, credential submissions, and app-triggered events may be recorded in System Logging Database 127 for audit, diagnostics, or behavioral analytics.

In some implementations, Mobile App Interface 119 may be customized or white-labeled for enterprise deployments, with modular UI components that can be tailored for package recipients, maintenance personnel, fleet coordinators, or infrastructure owners.

### 1.20 Logic Cycle Processor

Logic Cycle Processor 120 may be configured to coordinate the timing, execution flow, and state transitions of operations performed by Beacon Unit 103 and its associated subsystems within System 100. In some embodiments, Logic Cycle Processor 120 may function as the core orchestration engine for managing event-driven tasks, conditional branching, and multi-module synchronization throughout the lifecycle of a landing, takeoff, or payload exchange event.

Logic Cycle Processor 120 may operate as a stateful controller that monitors sensor inputs, authentication outcomes, and job metadata to determine the appropriate next action within an operational workflow. For example, upon detection of an inbound aerial vehicle via Drone Identification Module 117, Logic Cycle Processor 120 may initiate a logic cycle that triggers environmental assessment through Environmental Analysis Processor 109, generates a Virtual Protected Area via VPA Generation Module 114, and waits for user authentication via User Authentication Subsystem 118 before releasing a payload.

In various implementations, Logic Cycle Processor 120 may define and execute logic sequences that include conditional rules, timeouts, retries, escalations, or abort paths based on mission constraints or real-time system status. These sequences may be encoded as state machines, logic trees, or rule-based decision graphs that are dynamically updated based on feedback from internal modules such as Smart Contract Engine 102, ASG Engine 110, or Payload Verification Module 116.

Logic Cycle Processor 120 may also manage inter-component dependencies, ensuring that certain preconditions are satisfied before advancing to the next operational phase. For instance, a successful VPA classification by VPA Classification Engine 115 and a clear trajectory from ASG Engine 110 may be required before granting final landing clearance. If any of the dependencies are unmet or return an error, Logic Cycle Processor 120 may roll back, pause, or re-route the logic cycle accordingly.

In some embodiments, Logic Cycle Processor 120 may log the full execution trace of each logic cycle, including timestamps, state transitions, input/output values, and exception events, to System Logging Database 127. These traces may support diagnostic review, compliance reporting, or post-mission analytics.

Logic Cycle Processor 120 may be implemented using programmable logic, a microcontroller, or a dedicated software routine executing on shared compute infrastructure within Beacon Unit 103. In certain scenarios, it may operate autonomously or in collaboration with a remote orchestration service or system administrator through an external network interface.

### 1.21 Registered Relay Station

Registered Relay Station 121 may be configured to serve as a trusted communication, coordination, and oversight node within System 100, facilitating the secure exchange of information between aerial vehicles, beacon units, and cloud-based infrastructure. In some embodiments, Registered Relay Station 121 may operate as an edge computing hub or backend relay gateway that manages distributed tasks, stores system metadata, and enforces policy logic across multiple deployments of Beacon Unit 103.

Registered Relay Station 121 may maintain persistent connections with a plurality of beacon units deployed in different geographic locations and may act as a supervisory node responsible for scheduling, credential management, load balancing, or fault handling across the network. The relay station may also mediate communications between Smart Contract Engine 102 and decentralized ledgers, supporting blockchain synchronization and integrity verification of mission-critical transactions.

In various implementations, Registered Relay Station 121 may receive DERF-wrapped communication packets from inbound or outbound aerial vehicles via RF Transceiver Module 111 or through a satellite link and may route or transform these packets for downstream components such as Payload Verification Module 116 or User Authentication Subsystem 118. The relay station may decrypt, repackage, or validate the contents of these packets in accordance with system-wide rules or job-specific contract logic.

Registered Relay Station 121 may further maintain a registry of approved aerial vehicles, authorized users, active job assignments, and site-specific configurations. This registry may be consulted by Drone Identification Module 117 and VPA Classification Engine 115 to determine access eligibility or operational constraints for a particular job or vehicle class.

In certain embodiments, Registered Relay Station 121 may serve as a data aggregation point for environmental and operational telemetry collected from multiple Beacon Units 103. The relay station may preprocess, compress, and forward such data to a cloud-based analytics platform or may generate summary reports for compliance and oversight.

Registered Relay Station 121 may also support remote administrative access, enabling authorized personnel to issue updates, modify system rules, or trigger overrides across the networked infrastructure. In cases where Beacon Unit 103 loses direct connection to the relay station, fallback logic executed by Logic Cycle Processor 120 may maintain limited autonomy until connectivity may be restored.

All operational exchanges involving Registered Relay Station 121 may be logged in System Logging Database 127, and in some implementations, a mirrored copy of these logs may be retained at the relay station to support redundancy, resiliency, and disaster recovery.

### 1.22 Registered Charging Station

Registered Charging Station 122 (not shown) may be configured to provide authenticated, scheduled, and condition-aware recharging services for autonomous aerial vehicles operating within the coverage domain of System 100. In some embodiments, Registered Charging Station 122 may include a physical docking interface, a wireless or contact-based charging module, a communication subsystem, and one or more control processors configured to manage vehicle registration, energy transfer, and charging policy enforcement.

Registered Charging Station 122 may be geographically co-located with or independently deployed from Beacon Unit 103 and may coordinate with components such as Registered Relay Station 121, Drone Identification Module 117, and DERF Communication Module 101 to verify aerial vehicle identity, authorize charging access, and initiate recharging sessions.

Upon vehicle arrival, Registered Charging Station 122 may initiate a multi-stage verification sequence. This may include receipt of DERF-wrapped credentials from the aerial vehicle, validation of job or fleet authorization, and matching of vehicle metadata (e.g., serial number, battery class, mission status) with pre-registered profiles. Only upon successful authentication may the charging station engage the energy transfer subsystem.

In various implementations, Registered Charging Station 122 may support dynamic charging protocols optimized for vehicle type, battery chemistry, thermal conditions, and mission urgency. Charging profiles may include rapid charge, top-off, or scheduled slow charge modes and may be determined by logic rules executed either locally or in conjunction with a remote orchestration engine at Registered Relay Station 121.

The charging station may also include safety and monitoring features such as voltage sensors, thermal cutoff circuits, isolation mechanisms, and emergency disconnect logic. In some embodiments, Registered Charging Station 122 may include a weather enclosure or docking alignment system to protect and stabilize the aerial vehicle during charging cycles.

In addition to energy delivery, Registered Charging Station 122 may transmit and receive diagnostic data from the aerial vehicle, including battery health, usage statistics, and flight log summaries. These data may be uploaded to System Logging Database 127 for lifecycle analysis, warranty tracking, or maintenance scheduling.

In certain configurations, Registered Charging Station 122 may report availability and operational status to Beacon Control Interface 112 or be discoverable by nearby aerial vehicles through broadcast signals mediated by RF Transceiver Module 111 or Satellite Communication Link 123.

### 1.23 Satellite Communication Link

Satellite Communication Link 123 may be configured to provide long-range, resilient communication connectivity between components of System 100—such as Beacon Unit 103, Registered Relay Station 121, and autonomous aerial vehicles—and one or more remote infrastructure nodes or cloud-based services. In some embodiments, Satellite Communication Link 123 may function as a backup or complementary channel to ground-based RF or cellular networks, enabling system continuity in remote, obstructed, or degraded environments.

Satellite Communication Link 123 may include a satellite transceiver, directional or omnidirectional antenna array, and link management circuitry integrated with or co-located near Beacon Unit 103. The link may operate over low Earth orbit (LEO), medium Earth orbit (MEO), or geostationary satellite networks depending on coverage requirements and latency tolerances.

In various implementations, Satellite Communication Link 123 may be activated conditionally, such as when RF Transceiver Module 111 detects signal degradation, unavailability of terrestrial relays, or interference within the landing site's radio environment. The link may then relay DERF-wrapped messages, including vehicle identity verification data, environmental status reports, trajectory requests, and system state transitions, to Registered Relay Station 121 or cloud-hosted coordination services.

Satellite Communication Link 123 may further support global coordination and inter-beacon communication for drone fleets operating across wide geographies or in disconnected airspaces. For instance, a vehicle en route to a remote location may pre-register its landing request and receive trajectory clearance updates via satellite prior to entering local RF range of a Beacon Unit 103.

In some embodiments, Satellite Communication Link 123 may also be used for system maintenance, software updates, or remote diagnostics. For example, operators may push configuration changes or retrieve telemetry logs from isolated Beacon Units using authenticated and encrypted satellite uplinks and downlinks.

The link may include bandwidth and priority management logic, enabling it to throttle or queue data transmissions based on urgency, payload class, or operational tier. In mission-critical or emergency scenarios, Satellite Communication Link 123 may override standard communication modes to enable delivery of landing denials, rerouting commands, or collision avoidance notices.

All data transmissions handled by Satellite Communication Link 123 may be logged in System Logging Database 127, with metadata including satellite ID, transmission timestamps, signal quality metrics, and payload digests, to support traceability and post-mission analytics.

### 1.24 GPS Anchor Module

GPS Anchor Module 124 may be configured to provide precise geolocation reference data to support localization, navigation, and landing operations for autonomous aerial vehicles interacting with System 100. In some embodiments, GPS Anchor Module 124 may include a high-accuracy satellite positioning receiver, differential correction hardware, and interface logic configured to integrate with Beacon Unit 103 and associated guidance components such as ASG Engine 110 and VPA Generation Module 114.

GPS Anchor Module 124 may receive real-time signals from a constellation of Global Navigation Satellite Systems (GNSS), including but not limited to GPS, GLONASS, Galileo, or BeiDou, and may process these signals to determine its fixed geographic position with sub-meter or centimeter-level accuracy. This absolute position may be broadcast to nearby aerial vehicles or used internally by System 100 to support safe trajectory calculation and zone definition.

In various implementations, GPS Anchor Module 124 may serve as a local ground truth reference point, enabling aerial vehicles to align their flight paths relative to a known fixed coordinate. This may be particularly useful during vertical descent phases or when operating in environments with weak GNSS reception, urban multipath interference, or electromagnetic noise. In such scenarios, GPS Anchor Module 124 may provide differential GPS (DGPS) corrections or Real-Time Kinematic (RTK) enhancements to improve aerial vehicle positioning fidelity.

GPS Anchor Module 124 may interface with ASG Engine 110 to refine final approach vectors and enable designated Virtual Protected Areas (VPAs) generated by VPA Generation Module 114 are properly aligned with global coordinates and system-defined landing thresholds. The module may also serve as a reference point for dynamically adjusting VPA boundaries based on drift, calibration offset, or infrastructure movement (e.g., in mobile or temporary deployments).

In some embodiments, GPS Anchor Module 124 may broadcast beacon-specific coordinate identifiers or DERF-wrapped location signatures that allow incoming aerial vehicles to identify the correct landing site when multiple beacons are deployed in close proximity. The module may also support fallback navigation behavior, where vehicles use the last known coordinates from GPS Anchor Module 124 to complete a mission in the event of communication or sensor degradation.

GPS data captured or distributed by GPS Anchor Module 124 may be recorded in System Logging Database 127, along with timestamps, correction vectors, and satellite signal quality metrics, to support post-mission diagnostics, compliance reporting, or forensic review.

### 1.27 System Logging Database

System Logging Database 127 may be configured to capture, store, and organize operational, transactional, and environmental data generated by various components of System 100. In some embodiments, System Logging Database 127 may be implemented as a locally accessible datastore within Beacon Unit 103, a distributed ledger system, or a remote cloud-hosted repository accessible via Registered Relay Station 121 or Satellite Communication Link 123.

System Logging Database 127 may receive structured or semi-structured logs from modules including but not limited to DERF Communication Module 101, Smart Contract Engine 102, Environmental Analysis Processor 109, ASG Engine 110, VPA Classification Engine 115, Payload Verification Module 116, User Authentication Subsystem 118, and GPS Anchor Module 124. Each log entry may include metadata such as timestamps, system state transitions, environmental readings, credential verification results, command acknowledgments, and error flags.

In various implementations, System Logging Database 127 may support time-series indexing and hierarchical tagging to facilitate efficient querying and forensic reconstruction of drone-related activities. For example, in response to a compliance review or operational audit, System Logging Database 127 may be queried to reconstruct the sequence of events for a specific job, including VPA classification, user authentication events, trajectory guidance outputs, and payload release decisions.

System Logging Database 127 may further support data integrity and non-repudiation by cryptographically signing log entries or synchronizing with a blockchain via Smart Contract Engine 102. In such embodiments, the database may serve as a legal or regulatory artifact for proving proper system operation, verifying user or vehicle identities, or confirming adherence to predefined safety constraints.

In certain scenarios, System Logging Database 127 may also be used for analytics, training, or performance optimization. Logged data may be used to train machine learning models for improved environmental classification, fault prediction, or behavioral anomaly detection across drone landing cycles.

System Logging Database 127 may be configured to retain logs according to configurable data retention policies, which may vary depending on job criticality, operational domain, or privacy regulations. The database may also be queried by Mobile App Interface 119 or Registered Relay Station 121 for displaying historical reports, generating maintenance alerts, or updating system dashboards.

### 2. Method for Coordinated Autonomous Aerial Vehicle Ingress and Payload Exchange Via Smart Beacon System

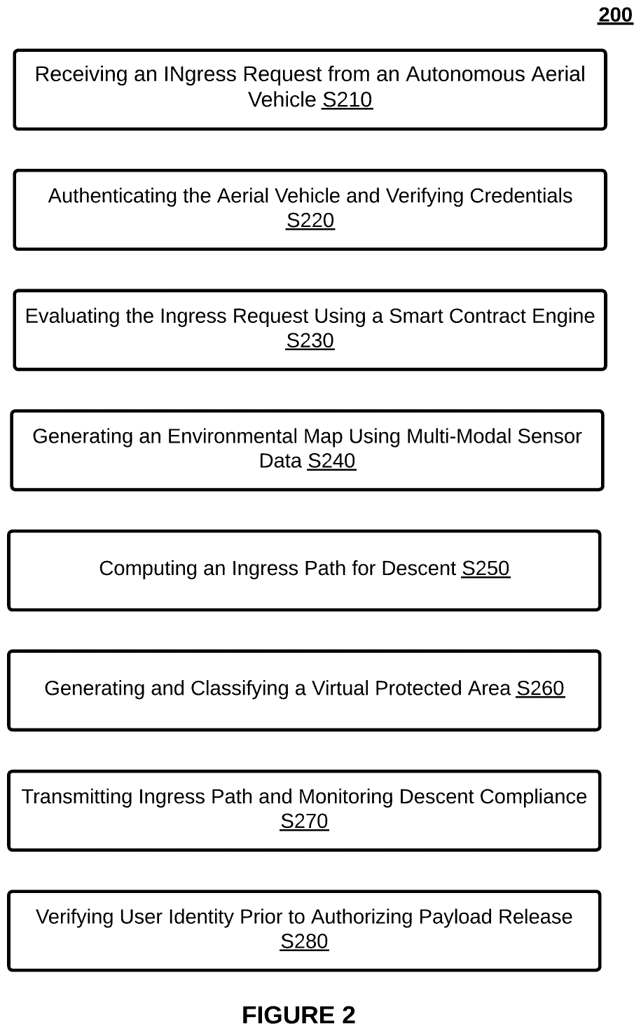

As shown by way of example in FIG. 2, a method 200 for managing autonomous aerial vehicle ingress and payload exchange includes receiving an ingress request from an autonomous aerial vehicle S210, authenticating the aerial vehicle and verifying credentials S220, evaluating the ingress request using a smart contract engine S230, generating an environmental map using multi-modal sensor data S240, computing an ingress path for descent S250, generating and classifying a virtual protected area S260, transmitting the ingress path and monitoring descent compliance S270, and verifying human user identity prior to authorizing payload release S280.

Method 200 may describe a computer-implemented, multi-phase process for coordinating the ingress of an autonomous aerial vehicle into a predefined operational airspace, facilitating payload verification and exchange, and ensuring environmental safety through a smart beacon system. The method may be executed by or in connection with components of System 100, including but not limited to DERF Communication Module 101, Smart Contract Engine 102, Environmental Analysis Processor 109, ASG Engine 110, VPA Generation Module 114, and User Authentication Subsystem 118. The described operations may occur in a time-sequenced and condition-aware manner and may be performed autonomously or semi-autonomously with limited human intervention. Method 200 may be initiated in response to the detection of an authorized aerial vehicle within range of a beacon unit, a scheduled landing request, or an authenticated delivery transaction, and may terminate following successful payload verification, handoff, or departure of the aerial vehicle from the landing zone. While certain steps are described as occurring in a particular sequence, it will be appreciated that various steps may be performed in parallel, repeated, or conditionally omitted depending on environmental state, policy logic, or system configuration.

### 2.1 Detect Aerial Vehicle and Initiate Ingress Protocol

S210, which includes receiving an ingress request, may function to initiate an ingress coordination session by acquiring a digitally encoded ingress request from an autonomous aerial vehicle, the request comprising an identity token tied to a delivery or retrieval operation. At Step S210, the system may detect the presence of an inbound autonomous aerial vehicle and initiate an ingress coordination protocol. Detection may occur through multiple modalities, including receipt of a DERF-wrapped signal via RF Transceiver Module 111, optical or thermal signature analysis performed by Environmental Analysis Processor 109, or identification of a geofenced proximity breach monitored by GPS Anchor Module 124.

In some embodiments, the aerial vehicle may broadcast a landing request signal that includes a unique mission identifier, vehicle credentials, and payload metadata. Drone Identification Module 117 may parse this signal to confirm that the aerial vehicle may be registered and authorized to interact with the designated Beacon Unit 103. The detection event may serve as the trigger for subsequent activation of the system's logic cycle, coordinated by Logic Cycle Processor 120.

Upon successful identification of the aerial vehicle, the system may log the detection event to System Logging Database 127 and initiate a handshake sequence to confirm bidirectional communication integrity. In some implementations, Registered Relay Station 121 may also be notified of the detection event for remote monitoring or scheduling coordination.

The ingress protocol may include optional pre-verification of vehicle authorization using Smart Contract Engine 102, along with a preliminary environmental check to enable safe airspace conditions for initiating descent. If system thresholds are satisfied, Logic Cycle Processor 120 may transition System 100 from an idle or standby state to an active coordination state in preparation for the environmental assessment and VPA generation phases described in subsequent steps.

### 2.2 Authenticate Aerial Vehicle and Authorize Landing Operations

S220, which includes authenticating the aerial vehicle and verifying credentials, may function to enable that the autonomous aerial vehicle may be recognized and trusted by extracting credential metadata and validating the data against a distributed identity registry maintained by a registered relay station. At Step S220, the system may authenticate the detected aerial vehicle and determine whether to authorize progression to landing operations. Authentication may be performed by Drone Identification Module 117 in conjunction with Smart Contract Engine 102, and may include verification of digital credentials, mission-specific access tokens, and vehicle registration data previously stored in a secure ledger or identity registry.

In some embodiments, the aerial vehicle may transmit a DERF-wrapped identity packet that includes a signed certificate, vehicle class identifier, mission hash, and operational attributes such as payload status or required landing time. Upon receipt of this packet, Drone Identification Module 117 may extract and parse the credential contents and validate them against records stored locally or remotely via Registered Relay Station 121.

Smart Contract Engine 102 may evaluate the mission request using embedded contract logic that reflects predetermined policy constraints, such as vehicle permissions, time windows, environmental constraints, delivery authorizations, or user-specific entitlements. If all contract conditions are satisfied, Smart Contract Engine 102 may generate an authorization response signal that enables subsequent landing coordination steps.

In certain implementations, the system may also cross-reference classification tiers, queue status, or operational flags associated with the aerial vehicle to determine whether to proceed with real-time trajectory planning. If the authentication fails, or if the system may be currently operating in a restricted or fault state, landing may be denied or deferred, and the vehicle may be instructed to hold or reroute.

Upon successful authentication, System Logging Database 127 may record the validation outcome, credential signature, timestamp, and vehicle metadata for auditing or post-mission traceability. Beacon Control Interface 112 may then transition the system to a preparatory state in anticipation of environmental analysis and VPA generation.

### 2.3 Analyze Local Environment and Generate Environmental Map

S230, which includes evaluating the ingress request using a smart contract engine, may function to determine authorization for ingress by executing a mission-specific smart contract against the identity token and other credential parameters. At Step S230, the system may initiate a localized environmental analysis to evaluate the safety, suitability, and spatial conditions of the landing zone. This analysis may be performed by Environmental Analysis Processor 109 using fused input data collected from a plurality of onboard sensor modules, including LiDAR Sensor Array 104, Radar Sensor Module 105, Infrared Sensor Unit 106, Audio Sensor Unit 107, and Weather Monitoring Unit 108.

In some embodiments, the environmental scan may be initiated automatically upon successful vehicle authentication (as described in S220) and may include active sensor sweeps to detect static and dynamic obstacles, terrain features, heat signatures, audio anomalies, weather conditions, and other variables within a predefined radius of Beacon Unit 103. The sensor data may be filtered, normalized, and aligned spatially to generate a three-dimensional environmental map representing current airspace conditions and ground-level accessibility.

Environmental Analysis Processor 109 may also classify nearby objects using rule-based or machine learning classifiers to differentiate between permissible landing surfaces, obstructions (e.g., structures, vegetation, or vehicles), and transient risks (e.g., human presence, weather fluctuations, or RF interference). In some implementations, historical environmental data may be referenced to enhance accuracy or apply predictive models for short-term forecasting.

The generated environmental map may serve as a foundational data structure for use by ASG Engine 110 and VPA Generation Module 114 in subsequent steps. It may include spatial coordinates, hazard boundaries, terrain gradients, confidence levels, and temporal decay metrics for time-sensitive features. If hazardous conditions are detected-such as moving obstructions, wind shear, or thermal anomalies-Beacon Control Interface 112 may flag the site as restricted or unsafe.

The completed environmental map and any associated metadata (e.g., sensor IDs, scan duration, resolution quality) may be logged to System Logging Database 127 to support future diagnostics, mission audits, or regulatory compliance.

### 2.4 Generate Virtual Protected Area (VPA) Based on Environmental Conditions

S240, which includes generating an environmental map using multi-modal sensor data, may function to assess current environmental conditions by integrating data collected from a LiDAR sensor array, radar module, infrared unit, audio sensors, and weather monitoring equipment. At Step S240, the system may generate a Virtual Protected Area (VPA) based on the environmental map produced in Step S230 and mission-specific parameters associated with the authenticated aerial vehicle. The VPA may be instantiated by VPA Generation Module 114 and may define a dynamic, three-dimensional spatial region designated for safe ingress, landing, and payload exchange operations.

The VPA may be configured as a geofenced zone with virtual boundaries computed using environmental scan data, trajectory vectors from ASG Engine 110, and landing clearance thresholds defined in policy logic or smart contract conditions. The VPA may specify coordinates for a descent corridor, horizontal clearance footprint, elevation limits, and temporal availability window, and may be adjusted in real time based on shifting environmental or mission constraints.

In various embodiments, VPA Generation Module 114 may generate a primary VPA and one or more secondary or fallback VPAs to provide operational redundancy in case of environmental fluctuation or unauthorized intrusion into the primary zone. Each VPA instance may be tagged with a unique identifier, classification tier, and permitted vehicle parameters, such as vehicle size class, payload mass limits, or maneuverability characteristics.

Visual Indicator Assembly 113 may be activated to signal the VPA status to local observers, such as green indicators for active clearance, yellow for standby or transitional status, and red for restricted or unsafe zones. Additionally, VPA metadata may be transmitted to the aerial vehicle using DERF-encoded messages via RF Transceiver Module 111, enabling the vehicle to confirm receipt and alignment before executing descent operations.

In some implementations, VPA Generation Module 114 may log the computed VPA boundary data, classification rationale, activation timestamp, and related vehicle identifiers to System Logging Database 127. The generated VPA may then be passed to VPA Classification Engine 115 for tier assignment and final validation before flight path instructions are issued.

### 2.5 Classify Virtual Protected Area and Validate for Ingress

S250, which includes computing an ingress path for descent, may function to generate a safe and efficient approach trajectory for the aerial vehicle by selecting an optimal descent vector based on obstacle locations, weather inputs, and safety constraints derived from the environmental map. At Step S250, the system may classify the Virtual Protected Area (VPA) generated in Step S240 based on real-time environmental conditions, spatial characteristics, and mission-specific constraints. This classification process may be executed by VPA Classification Engine 115 and may determine the operational tier, access eligibility, and safety readiness of the VPA prior to initiating autonomous vehicle ingress.

The classification process may involve evaluating inputs such as obstacle density, terrain clearance, wind velocity, weather stability, and detected anomalies within or surrounding the VPA. Each environmental parameter may be weighted according to preconfigured classification criteria, and the aggregated result may be used to assign the VPA a classification level (e.g., Class A, B, C, or D), where Class A indicates optimal conditions and Class D reflects marginal or restricted operability.

In some embodiments, VPA Classification Engine 115 may consult historical environmental trends or predictive models to evaluate potential risks over the expected landing window. For example, a VPA deemed safe at the time of generation may be downgraded if incoming weather systems, dynamic obstructions, or environmental degradation are predicted within a relevant timeframe.

Classification decisions may also account for the capabilities of the approaching aerial vehicle, including descent profile precision, required clearance buffer, propulsion reliability, or autonomy tier. A vehicle with high-performance specifications may be granted access to a Class B VPA, whereas a more restricted vehicle may be denied access until a Class A VPA becomes available.

Once the classification tier may be determined, VPA Classification Engine 115 may validate the VPA for ingress. If the VPA satisfies all system-defined and vehicle-specific requirements, an ingress clearance may be issued. Conversely, if the classification falls below the system's minimum threshold, the VPA may be invalidated or re-evaluated following a re-scan or delay.

The assigned classification tier, supporting environmental metrics, validation outcome, and timestamped decision rationale may be logged to System Logging Database 127 for audit, compliance, or diagnostics purposes. A status update reflecting the classification outcome may also be visually indicated via Visual Indicator Assembly 113 and communicated to the aerial vehicle through DERF-encoded transmission.

### 2.6 Transmit Ingress Trajectory and Descent Instructions to Aerial Vehicle

S260, which includes generating and classifying a virtual protected area, may function to define a dynamically sized three-dimensional descent zone centered on the beacon unit and assess the zone's safety level using system-defined criteria applied to current environmental factors. At Step S260, the system may transmit an ingress trajectory and associated descent instructions to the authenticated aerial vehicle based on the validated Virtual Protected Area (VPA) and its assigned classification. This operation may be coordinated by ASG Engine 110, in conjunction with Beacon Control Interface 112 and RF Transceiver Module 111, to enable that the aerial vehicle receives accurate, context-aware guidance for approaching and entering the VPA.

ASG Engine 110 may calculate an optimal flight path into the VPA using the environmental map generated in Step S230, current vehicle telemetry, classification tier from Step S250, and any mission-specific descent preferences or constraints. The calculated trajectory may include waypoints, velocity thresholds, altitude targets, lateral margins, and rate-of-descent parameters that may be required to enable safe navigation through the designated ingress corridor.

In some embodiments, the trajectory may be dynamically shaped to avoid localized obstructions or transient hazards identified during environmental analysis. ASG Engine 110 may also enforce no-fly buffer zones around the VPA to prevent path conflicts with other aerial vehicles or objects operating in adjacent airspace.

Once the trajectory has been computed, the system may encode the guidance data into a DERF-wrapped transmission and broadcast the packet to the aerial vehicle via RF Transceiver Module 111. The guidance data may include a digital signature to authenticate the message source and enable tamper resistance. In certain implementations, the trajectory packet may include a checksum or hash to confirm complete and accurate receipt by the vehicle.

Upon receipt, the aerial vehicle may acknowledge the transmission, validate the path, and transition into an ingress-ready state. In response, Beacon Control Interface 112 may initiate a real-time monitoring mode to track vehicle compliance with the assigned path and respond to deviations, signal loss, or environmental changes.

The trajectory computation parameters, transmission log, acknowledgment signal, and any adjustments made prior to descent may be stored in System Logging Database 127 for future analysis, mission reconstruction, or airspace compliance verification.

### 2.70 Initiate Descent and Monitor Real-Time Landing Conditions

S270, which includes transmitting the ingress path and monitoring descent compliance, may function to relay trajectory guidance instructions to the aerial vehicle and enable adherence to the computed ingress path by tracking telemetry data in real time and detecting deviations. At Step S270, the authenticated aerial vehicle may initiate its descent along the ingress trajectory received in Step S260, and the system may continuously monitor real-time landing conditions to enable safety, accuracy, and conformance with system-defined operational parameters. This step may involve coordinated execution of trajectory adherence verification, environmental re-evaluation, and landing clearance maintenance.

As the aerial vehicle begins its approach into the Virtual Protected Area (VPA), ASG Engine 110 and Environmental Analysis Processor 109 may jointly monitor descent progress using telemetry signals, sensor feedback, and positional data derived from GPS Anchor Module 124. Real-time data such as altitude, velocity, yaw/pitch/roll attitude, and descent alignment may be received from the aerial vehicle and compared against the planned ingress profile to detect deviations or anomalies.

Environmental Analysis Processor 109 may perform continuous or periodic re-scanning of the VPA to detect the emergence of new hazards, such as moving objects, human presence, adverse weather changes, or unexpected surface anomalies. If such conditions are identified, Logic Cycle Processor 120 may dynamically adjust the ingress procedure, suspend descent, or command the aerial vehicle to abort landing and enter a holding pattern.

In some embodiments, Visual Indicator Assembly 113 may reflect the current landing status through real-time signal updates, while Payload Verification Module 116 and User Authentication Subsystem 118 may prepare for post-landing procedures. System Logging Database 127 may record telemetry data, ingress timestamp, environmental state snapshots, and compliance metrics throughout the descent sequence.

If all monitored parameters remain within acceptable thresholds, and no abort conditions are triggered, the system may maintain active clearance and allow the aerial vehicle to complete its landing within the defined VPA footprint. Upon final touchdown, the system may transition to the next phase of the operation, typically involving user authentication and payload verification.

### 2.71 Verify Ingress Trajectory Compliance During Descent

S280, which includes verifying a user identity prior to authorizing payload release, may function to authenticate the designated recipient at the landing zone before enabling the aerial vehicle to release a payload, ensuring the security of the final exchange phase. At Substep S271, the system may verify that the aerial vehicle remains in compliance with the ingress trajectory transmitted in Step S260 as it descends toward the designated Virtual Protected Area (VPA). Substep S271 may involve continuous monitoring of vehicle position, orientation, and flight vector parameters relative to the predefined descent corridor. It shall be recognized that, while S280 may generally operate to authenticate a human user, any type or kind of user or entity (e.g., machine, computing device, and/or the like) may be authenticated prior to authorizing payload release.

Compliance verification may be performed by ASG Engine 110 using telemetry data received in real time from the aerial vehicle, including but not limited to geospatial coordinates, altitude, pitch, roll, yaw, and velocity. This telemetry may be cross-referenced with the planned waypoints and trajectory envelope to detect deviations beyond permitted tolerances.

In some embodiments, ASG Engine 110 may define a dynamic compliance boundary that allows for minor in-flight adjustments due to environmental variability (e.g., gusting wind or signal drift), while still enforcing core safety requirements. If the aerial vehicle strays outside of the acceptable corridor bounds, a compliance violation may be flagged, and the system may trigger an automatic correction signal, descent pause, or emergency abort instruction.

Visual Indicator Assembly 113 may also update its status indicators in response to compliance status, providing visual feedback to nearby observers or system administrators. Additionally, compliance logs—including deviation metrics, correction attempts, and recovery timestamps—may be recorded in System Logging Database 127 to support post-operation analysis or fault tracing.

In certain implementations, Smart Contract Engine 102 may include compliance conditions that are evaluated in real time. If any contractual trajectory rules are violated, payload delivery authorization may be suspended or invalidated, and the mission may be re-queued for reassessment.

### 2.72 Reevaluate Environmental Conditions During Descent

At Substep S272, the system may continuously or intermittently reevaluate environmental conditions within and around the Virtual Protected Area (VPA) as the aerial vehicle proceeds along its descent trajectory. This real-time environmental reassessment may be executed by Environmental Analysis Processor 109 using data collected from onboard and beacon-associated sensors, including LiDAR Sensor Array 104, Radar Sensor Module 105, Infrared Sensor Unit 106, Audio Sensor Unit 107, and Weather Monitoring Unit 108.

At least one technical benefit of substep S272 includes detecting and responding to emerging hazards or changes in landing zone viability that were not present, or not observable, during the initial scan and VPA classification performed in earlier steps. Such conditions may include, for example, new obstructions (e.g., people, vehicles, debris), degraded weather (e.g., increased wind speed, precipitation), electromagnetic interference, or surface instability within the landing zone.

In some embodiments, Environmental Analysis Processor 109 may compare current sensor readings against baseline environmental data collected during Step S230. The system may flag deviations that exceed predefined risk thresholds and classify them according to severity, permanence, and proximity to the vehicle's path.

If a risk condition may be identified, Logic Cycle Processor 120 may dynamically modify the landing workflow, potentially issuing a pause command, switching to a fallback VPA, or executing an emergency hold or abort sequence. ASG Engine 110 may adjust the descent path in real time to accommodate minor disruptions while preserving trajectory compliance as verified in Substep S271.

The results of each environmental reassessment cycle, including updated sensor readings, detection flags, and action responses, may be stored in System Logging Database 127 and used to refine future classifications and decision models.

### 2.80 Authenticate User and Verify Payload Exchange Authorization

S280, which includes verifying a human user identity prior to authorizing payload release, may function to authenticate the designated recipient at the landing zone before enabling the aerial vehicle to release a payload, ensuring the security of the final exchange phase. At Step S280, the system may authenticate the human user located at or near the landing site and verify that the payload exchange—either delivery or pickup—is authorized according to mission parameters and system policy. This step enables secure, auditable interaction between the aerial vehicle and a verified recipient and may be managed by User Authentication Subsystem 118 and Payload Verification Module 116 in coordination with Beacon Control Interface 112.

Authentication may be initiated once the aerial vehicle reaches a predefined landing state and the system confirms that environmental and positional criteria remain satisfied. The user may be prompted via Mobile App Interface 119 or through a local interface to present identification credentials, such as a QR code, biometric input, time-sensitive access token, or cryptographic signature. These credentials may be validated against access permissions defined in a mission-specific smart contract managed by Smart Contract Engine 102.

Simultaneously, Payload Verification Module 116 may cross-reference metadata from the aerial vehicle's payload bay, such as payload ID, seal integrity status, or weight verification, with mission records to confirm that the correct payload is being transferred to the correct user.

In some embodiments, multi-factor authentication may be employed, combining digital credentials with sensor-derived confirmations such as heat signatures from Infrared Sensor Unit 106 or voiceprint analysis via Audio Sensor Unit 107. If the system determines that the user and payload both match the authorized job parameters, a payload release command may be issued to the aerial vehicle.

If authentication fails or cannot be conclusively resolved, the system may deny payload release, issue an alert, or initiate a retry or escalation procedure. All authentication inputs, verification outcomes, timestamps, and transfer results may be logged in System Logging Database 127 for audit and compliance purposes.

### 2.90 Finalize Exchange, Log Transaction, and Prepare for Vehicle Departure

Optionally, S290, which includes commanding, by the beacon control interface, the autonomous aerial vehicle using an omnidirectional transmission protocol, may function to broadcast ingress-related instructions across multiple directional channels simultaneously, thereby enabling real-time coordination with one or more aerial vehicles or ground relay systems operating within a defined operational radius. At Step S290, the system may finalize the payload exchange operation, record all associated transaction data, and initiate procedures to prepare the aerial vehicle and beacon site for departure and system reset. This step may be triggered upon confirmation that the user has been successfully authenticated and that the payload transfer, whether delivery or pickup, has been completed in accordance with system rules and mission parameters.

Following confirmation, Payload Verification Module 116 and Beacon Control Interface 112 may jointly validate the job completion status. The aerial vehicle may transmit a confirmation signal containing delivery status, payload bay state (e.g., empty or full), vehicle diagnostics, and a readiness indicator for departure. Onboard sensors may further verify the physical handoff by detecting changes in payload weight, container latch status, or packaging integrity.

System Logging Database 127 may be updated with a comprehensive transaction record, including the timestamp of delivery or pickup, the vehicle identification and flight metadata, the recipient's credential type and method of authentication, the classification tier of the Virtual Protected Area (VPA), and a snapshot of the environmental conditions at the time of exchange. Any anomalies encountered during the process, such as retry events, signal dropouts, or delayed confirmation, may also be recorded.

Smart Contract Engine 102 may perform post-condition validation to confirm contractual fulfillment, and may trigger external actions such as releasing payment, generating notifications, or submitting regulatory audit entries, depending on the terms encoded in the smart contract.

After successful logging and validation, Beacon Control Interface 112 may issue a departure clearance to the aerial vehicle. ASG Engine 110 may optionally compute a departure trajectory optimized for the current environmental state and active airspace constraints. Upon departure, the aerial vehicle may exit the geofenced VPA and transition into outbound flight mode.

The system may revert to a standby or idle state. Visual Indicator Assembly 113 may signal completion or site reset, while Environmental Analysis Processor 109 may purge temporary scan data or archive landing zone telemetry. The beacon site may thus be prepared for subsequent missions or shutdown, depending on operational configuration.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the present application without departing from the scope thereof defined in the following claims.

We claim:

1. A computer-implemented method for managing autonomous aerial vehicle ingress and payload exchange, the method comprising:
receiving, by a beacon unit, a digitally encoded ingress request from an autonomous aerial vehicle, the ingress request comprising an identity token associated with a delivery operation or a retrieval operation by the autonomous aerial vehicle;
evaluating, by a smart contract engine, the identity token against a mission-specific condition set to determine whether the autonomous aerial vehicle is authorized to initiate ingress operations;
generating, by an environmental analysis processor, an environmental map of a region surrounding the beacon unit using data from a plurality of sensors;
computing, by a trajectory guidance engine, an ingress path for the autonomous aerial vehicle based on the environmental map and a location of the beacon unit;
generating, by a virtual protected area generation module, a three-dimensional protected zone for descent and landing of the autonomous aerial vehicle;
assigning, by a classification engine, a safety classification to the virtual protected area based on the environmental map and one or more system-defined safety criteria;
transmitting, by a beacon control interface, the ingress path to the autonomous aerial vehicle and monitoring descent compliance with the ingress path; and
verifying, by a user authentication subsystem, an identity of a user located at the landing zone before authorizing release of a payload by the autonomous aerial vehicle.

2. The method of claim 1, further comprising:
prior to evaluating the identity token, authenticating the autonomous aerial vehicle by parsing the ingress request to extract credential metadata including a signed certificate and mission identifier, and verifying the credential metadata against a distributed identity registry maintained by a registered relay station.

3. The method of claim 2, wherein evaluating the identity token comprises:
executing a smart contract that defines delivery authorization parameters based on at least one of (i) a delivery time window, (ii) a location constraint relative to the beacon unit, and (iii) an identity of the intended recipient, wherein the smart contract is cryptographically validated using a blockchain-based authentication framework.

4. The method of claim 1, wherein receiving the digitally encoded ingress request comprises:
detecting, by the beacon unit, a proximity-based signal transmitted by the autonomous aerial vehicle using a wireless communication protocol, wherein the beacon unit initiates an ingress protocol in response to detecting the signal.

5. The method of claim 4, wherein the beacon unit further comprises a logic cycle processor configured to:
transition the system from an idle state to an active coordination state upon detection of the autonomous aerial vehicle within a predefined geofence radius.

6. The method of claim 5, further comprising:
verifying, by the beacon unit, that bidirectional communication has been established with the autonomous aerial vehicle by executing a multi-phase handshake protocol prior to authorizing descent.

7. The method of claim 6, wherein the beacon unit is further configured to:
monitor real-time telemetry from the autonomous aerial vehicle during descent to verify compliance with the ingress path, and to issue a hold or abort command if a deviation from a predefined compliance boundary is detected.

8. The method of claim 7, wherein the beacon unit is further configured to:
broadcast a visual indicator signal via a visual indicator assembly to signify a current landing status, wherein the visual indicator signal comprises a first state indicating ingress approval and a second state indicating restricted airspace.

9. The method of claim 8, wherein the beacon unit comprises:
a transceiver module configured to relay environmental status updates and ingress coordination instructions to the autonomous aerial vehicle using digitally encoded, cryptographically signed transmissions.

10. The method of claim 1, wherein computing the ingress path comprises:
generating, by the trajectory guidance engine, a plurality of candidate descent vectors based on obstacle boundaries identified in the environmental map, and selecting an optimal ingress path that minimizes lateral deviation and descent time while maintaining compliance with predefined safety thresholds.

11. The method of claim 1, wherein generating the three-dimensional protected zone comprises:
defining a set of virtual boundary coordinates that form a geofenced volume around the beacon unit, wherein the boundaries are dynamically sized based on at least one of: an ambient obstacle density, a forecasted weather condition, and a size classification of the autonomous aerial vehicle.

12. The method of claim 1, wherein assigning the safety classification comprises:
computing a risk score based on environmental variables within the virtual protected area, including obstacle motion vectors, thermal gradients, and ambient wind variability, and mapping the risk score to a predefined classification tier selected from a plurality of safety levels.

13. The method of claim 1, wherein monitoring descent compliance comprises:
tracking the position and orientation of the autonomous aerial vehicle in real time using telemetry signals received from the vehicle and comparing the tracked flight data against the ingress path to detect deviations exceeding a predefined compliance threshold.

14. The method of claim 1, wherein the beacon unit is further configured to dynamically modify the ingress path in response to a change in environmental conditions detected during descent of the autonomous aerial vehicle.

15. The method of claim 1, further comprising:
upon successful payload exchange, transmitting, by the beacon unit, a delivery confirmation signal to the autonomous aerial vehicle and to a remote relay station, the confirmation signal including a transaction identifier and payload status.

16. The method of claim 1, wherein:
the ingress request includes a unique flight mission code, and
the smart contract engine is configured to determine a mission-specific behavioral policy based on the flight mission code prior to authorizing ingress.

17. The method of claim 1, wherein the beacon unit is configured to perform omnidirectional commanding by broadcasting ingress coordination instructions simultaneously across a plurality of directional communication channels, the omnidirectional broadcast including ingress approval, hold, or abort signals encoded with cryptographic validation.

18. A system for managing autonomous aerial vehicle ingress and payload exchange, the system comprising:
a beacon unit configured to define a landing zone and interact with an autonomous aerial vehicle;
a communication module configured to receive a digitally encoded request from the autonomous aerial vehicle, the digitally encoded request including an identity token associated with a delivery or retrieval operation;
a smart contract engine configured to evaluate the identity token against a mission-specific condition set to determine whether the autonomous aerial vehicle is authorized to proceed with ingress operations;
an environmental analysis processor coupled to a plurality of sensor modules comprising a LiDAR sensor array, a radar sensor module, an infrared sensor unit, an audio sensor unit, and a weather monitoring unit, the environmental analysis processor configured to generate an environmental map of a region surrounding the beacon unit;
a trajectory guidance engine configured to compute an ingress path for the autonomous aerial vehicle based on the environmental map and a location of the beacon unit;
a virtual protected area generation module configured to define a three-dimensional protected zone for descent and landing of the autonomous aerial vehicle;
a classification engine configured to assign a safety classification to the virtual protected area based on the environmental map and system-defined safety criteria;
a beacon control interface configured to transmit the ingress path to the autonomous aerial vehicle and monitor compliance during descent; and
a user authentication subsystem configured to verify an identity of a user at the landing zone prior to authorizing release of a payload by the autonomous aerial vehicle.

19. A method comprising:
receiving, by a beacon unit, a digitally encoded ingress request from an autonomous aerial vehicle, the ingress request comprising an identity token associated with a delivery or retrieval operation;
evaluating, by a smart contract engine, the identity token against a mission-specific condition set to determine whether the autonomous aerial vehicle is authorized to initiate ingress operations;
generating, by an environmental analysis processor, an environmental map of a region surrounding the beacon unit using data from a plurality of sensor modules comprising a LiDAR sensor array, a radar sensor module, an infrared sensor unit, an audio sensor unit, and a weather monitoring unit;
computing, by a trajectory guidance engine, an ingress path for the autonomous aerial vehicle based on the environmental map and a location of the beacon unit; and
transmitting, by a beacon control interface, the ingress path to the autonomous aerial vehicle and monitoring descent compliance with the ingress path.

20. The method according to claim 19, further comprising:
generating, by a virtual protected area generation module, a three-dimensional protected zone for descent and landing of the autonomous aerial vehicle;
assigning, by a classification engine, a safety classification to the virtual protected area based on the environmental map and one or more system-defined safety criteria; and
verifying, by a user authentication subsystem, an identity of a user located at the landing zone before authorizing release of a payload by the autonomous aerial vehicle.
